(19) United States
(12) Patent Application Publication
(10) Pub. No.: US 2025/0209405 A1
(43) Pub. Date: Jun. 26, 2025

(54) METHOD AND SYSTEM FOR IMPLEMENTING A VALUES-BASED DECISION-MAKING, DIAGNOSTICS AND REPORTING TOOL

(71) Applicant: JPMorgan Chase Bank, N.A., New York, NY (US)

(72) Inventors: Aryeh WEINSTEIN, Berkeley, CA (US); Christopher DIMITRIOU, Portland, OR (US); Adelina J. KIM, Torrance, CA (US); Jiaqi LIU, Philadelphia, PA (US); Demetris MARNERIDES, London (GB); Stefanos MARNERIDES, Larnaca (CY); Conor MURRAY, Alameda, CA (US); Jacob H. RADEN, Los Angeles, CA (US); Jimmy SUN, Norfolk, MA (US)

(73) Assignee: JPMorgan Chase Bank, N.A., New York, NY (US)

(21) Appl. No.: 18/391,080

(22) Filed: Dec. 20, 2023

(51) Int. Cl. G06Q 10/0637; G06Q 40/06

(52) U.S. Cl. CPC G06Q 10/0637; G06Q 40/06

(57) ABSTRACT

A system for implementing a values-based decision-making, diagnostics, and reporting tool. The system may include a processor and memory that stores instructions that, when executed by the processor, cause the processor to perform operations. The operations may include: identifying at least one first source that provides client data that indicates at least one from among a client preference, a client behavior, and a client profile; obtaining the client data from the at least one first source; utilizing the client data to generate a set of personalized client values that indicates a set of values of a client; and utilizing the set of personalized client values to generate an values-based assessment for the client.

### BACKGROUND

### 1. Field of the Invention

The field of the invention disclosed herein generally relates to a system for implementing a decision-making, diagnostics, and reporting tool and, more particularly, to a method, system, and computer-readable storage medium for implementing technology for a decision-making, diagnostics, and reporting tool that evaluates information pertaining to one or more businesses.

### 2. Background of the Invention

Over recent years, there has been a growing awareness of the impact that businesses have on society and the environment, which has led to a shift in the decision-making practices of an increasing number of individuals and organizations throughout the world. As more information has become available regarding the impacts of businesses around the world, for example environmental, social, and/or governance (ESG) impacts, more effort has been made to assess and account for that information when making decisions.

These responsible decision-making efforts promote decisions that place the actual relationships that an individual (or organization) has with various businesses, in alignment with the relationships that exist between the values of that individual (or organization) and the corresponding impacts of those various businesses. However, many studies have shown that businesses who have strong ESG practices tend to outperform their peers over the long term.

Therefore, another benefit of values-based decision-making is that such responsible decisions tend to promote, and lead to relationships with, better performing businesses. In addition, this innovation helps users express their preferences/values in their financial lives-investments, spending, donations, etc. In other words, values-based decision-making strategies such as impact decision-making, socially responsible decision-making, and ESG decision-making, for example, tend to provide a combination of benefits that include philanthropic impact and favorable performance.

Unfortunately, the vast amount of information available regarding the impacts that businesses have all over the world is now so voluminous that it has become impossible for groups and individuals to reliably gather, assess, and account for all of that information manually. Moreover, the technology that is currently available for the automated management of such information is unable to provide interested groups and individuals with comprehensive values-based feedback on that information, far less the ability to tailor one or more values-based decision-making, diagnostics, and/or reporting strategies to a particular group or individual.

Accordingly, there is a need in the field of the herein-disclosed invention for a technical solution to the foregoing limitations in the technology of existing decision-making, diagnostics, and reporting tools.

### SUMMARY

The present disclosure, through one or more of its various aspects, embodiments, and/or specific features or sub-component, provides, inter alia, various systems, servers, devices, methods, media, programs and platforms for implementing a values-based decision-making, diagnostics, and reporting tool that evaluates how a client's values align with values-based information pertaining to one or more businesses.

According to an aspect of the present disclosure, a method is provided for implementing a values-based decision-making, diagnostics, and reporting tool. The method may comprise: identifying at least one first source that provides client data that indicates at least one from among a client preference, a client behavior, and a client profile; obtaining the client data from the at least one first source; utilizing the client data to generate a set of personalized client values; and utilizing the set of personalized client values to generate a values-based assessment for the client.

In the method, the values-based assessment may comprise at least one nonprofit organization that is associated with values-based information that aligns with the set of personalized client values of the client.

In the method, generating the values-based assessment may comprise: identifying at least one second source that provides business values data that comprises values-based information that is associated with an entity that is associated with a business, wherein the values-based information comprises information that indicates at least one value of the entity that is associated with the business; obtaining the business values data from the at least one second source; determining at least one values-based correlation by comparing the set of personalized client values to the business values data; and utilizing the at least one values-based correlation to generate the values-based assessment. The values-based assessment may comprise an indication of the at least one values-based correlation.

The method may further comprise: utilizing natural language processing (NLP) to search a data network for at least one from among the client data and the business values data; identifying a source of the at least one from among the client data and the business values data; and determining that at least one from among the first source and the second source corresponds to the source of the at least one from among the client data and the business values data, respectively.

In the method, the values-based assessment may further comprise a customized basket of a plurality of specified products that are associated with one or more entities that are each associated with conforming values-based information that aligns with the set of personalized client values of the client.

In the method, the generating the values-based assessment may further comprise: utilizing the business values data to identify, from a portfolio of the client, at least one client-held product that is associated with at least one entity that is associated with nonconforming values-based information that conflicts with the set of personalized client values of the client; and generating a notification that indicates that the at least one client-held product is associated with the at least one entity that is associated with the nonconforming values-based information that conflicts with the set of personalized client values of the client.

The method may further comprise generating a report that indicates how the at least one value of the client relates to each entity that is associated with one or more products from the portfolio of the client. The report may comprise one or more impact metrics that indicate how the portfolio impacts one or more corresponding values of the client.

In the method, the products may include a financial instrument that may comprise one from among an equity instrument and a debt instrument.

In the method, the one or more impact metrics may utilize a standardized index as a baseline for indicating how the portfolio impacts the one or more corresponding values.

According to another aspect of the present disclosure, a system is provided for implementing a values-based decision-making, diagnostics, and reporting tool. The system may comprise: a processor; and memory storing executable instructions. When executed by the processor, the instructions may cause the processor to: identify at least one first source that provides client data that indicates at least one from among a client preference, a client behavior, and a client profile; obtain the client data from the at least one first source; utilize the client data to generate a set of personalized client values; and utilize the set of personalized client values to generate a values-based assessment for the client.

In the system, the values-based assessment may comprise at least one nonprofit organization that is associated with values-based information that aligns with the set of personalized client values of the client.

In the system, when executed by the processor, the instructions may further cause the processor to generate the values-based assessment by: identifying at least one second source that provides business values data that comprises values-based information that is associated with an entity that is associated with a business; obtaining the business values data from the at least one second source; determining at least one values-based correlation by comparing the set of personalized client values to the business values data; and utilizing the at least one values-based correlation to generate the values-based assessment. The values-based information may comprise information that indicate at least one value of the entity that is associated with the business, and the values-based assessment may comprise an indication of the at least one values-based correlation.

In the system, when executed by the processor, the instructions may further cause the processor to: utilize natural language processing (NLP) to search a data network for at least one from among the client data and the business values data; identify a source of the at least one from among the client data and the business values data; and determine that at least one from among the first source and the second source corresponds to the source of the at least one from among the client data and the business values data, respectively.

In the system, the values-based assessment may further comprise a customized basket of a plurality of specified products that are associated with one or more entities that are each associated with conforming values-based information that aligns with the set of personalized client values of the client.

In the system, when executed by the processor, the instructions may further cause the processor to perform the generating the values-based assessment by: utilizing the business values data to identify, from a portfolio of the client, at least one client-held product that is associated with at least one entity that is associated with nonconforming values-based information that conflicts with the set of personalized client values of the client; and generating a notification that indicates that the at least one client-held product is associated with the at least one entity that is associated with the nonconforming values-based information that conflicts with the set of personalized client values of the client.

In the system, when executed by the processor, the instructions may further cause the processor to generate a report that indicates how the at least one value of the client relates to each entity that is associated with one or more products from the portfolio of the client. The report may comprise one or more impact metrics that indicate how the portfolio impacts one or more corresponding values of the client.

In the system, the product may include a financial instrument that may comprise one from among an equity instrument and a debt instrument.

In the system, the one or more impact metrics may utilize a standardized index as a baseline for indicating how the portfolio impacts the one or more corresponding values.

According to yet a further aspect of the present disclosure, a non-transitory computer-readable medium is provided for implementing a values-based decision-making, diagnostics, and reporting tool. The non-transitory computer-readable medium may store instructions that, when executed by a processor, cause the processor to: identify at least one first source that provides client data that indicates at least one from among a client preference, a client behavior, and a client profile; obtain the client data from the at least one first source; utilize the client data to generate a set of personalized client values; and utilize the set of personalized client values to generate a values-based assessment for the client.

In the non-transitory computer-readable medium, the values-based assessment may comprise at least one nonprofit organization that is associated with values-based information that aligns with the set of personalized client values of the client.

In the non-transitory computer-readable medium, when executed by the processor, the instructions may further cause the processor to generate the values-based assessment by: identifying at least one second source that provides business values data that comprises values-based information that is associated with an entity that is associated with a business; obtaining the business values data from the at least one second source; determining at least one values-based correlation by comparing the set of personalized client values to the business values data; and utilizing the at least one values-based correlation to generate the values-based assessment. The values-based information may comprise information that indicates at least one values-based value of the entity that is associated with the business, and the values-based assessment may comprise an indication of the at least one values-based correlation.

In the non-transitory computer-readable medium, when executed by the processor, the instructions may further cause the processor to: utilize natural language processing (NLP) to search a data network for at least one from among the client data and the business values data; identify a source of the at least one from among the client data and the financial instrument data; and determine that at least one from among the first source and the second source corresponds to the source of the at least one from among the client data and the business values data, respectively.

In the non-transitory computer-readable medium, the values-based assessment may further comprise a customized basket of a plurality of specified products that are associated with one or more entities that are each associated with conforming values-based information that aligns with the set of personalized client values of the client.

In the non-transitory computer-readable medium, when executed by the processor, the instructions may further cause the processor to perform the generating the values-based assessment by: utilizing the business values data to identify, from a portfolio of the client, at least one client-held product that is associated with at least one entity that is associated with nonconforming values-based information that conflicts with the set of personalized client values of the client; and generating a notification that indicates that the at least one client-held product is associated with the at least one entity that is associated with the nonconforming values-based information that conflicts with the set of personalized client values of the client.

In the non-transitory computer-readable medium, when executed by the processor, the instructions may further cause the processor to: generate a report that indicates how the at least one value of the client relates to each entity that is associated with one or more products from the portfolio of the client. The report may comprise one or more impact metrics that indicate how the portfolio impacts one or more corresponding values of the client.

In the non-transitory computer-readable medium, the product may include a financial instrument that may comprise one from among an equity instrument and a debt instrument.

In the non-transitory computer-readable medium, the one or more impact metrics may utilize a standardized index as a baseline for indicating how the portfolio impacts the one or more corresponding values.

Thereby, the invention disclosed herein improves existing technology by providing an ideal-state customizable platform agnostic solution that combines a client-specific decision history with that client's preferences in values-based decision-making strategies.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 is a diagram of an exemplary computer system.

FIG. 2 is a diagram of an exemplary network environment that implements a Values-based Decision-making, Diagnostics, and Reporting Tool.

FIG. 3 is a diagram of an exemplary perspective of a network environment that utilizes a Values-based Decision-making, Diagnostics, and Reporting Tool to evaluate values-based information.

FIG. 4 is a flowchart of an exemplary process for implementing a Values-based Decision-making, Diagnostics, and Reporting Tool that evaluates values-based information.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out steps necessary to implement the methods of the examples of this technology that are described and illustrated herein.

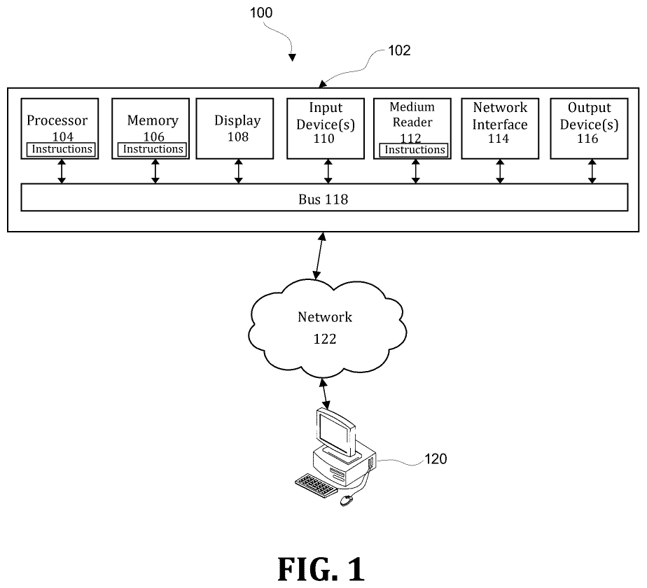

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for implementing a Values-based Decision-making, Diagnostics, and Reporting Tool that evaluates how a client's values align with values-based information that pertain to one or more businesses, such as environmental, social, and/or governance (ESG) information pertaining to one or more businesses, for example. However, in an additional or alternative embodiment, the values-based information described herein may comprise geographical location (and/or proximity) information or other information pertaining to one or more businesses.

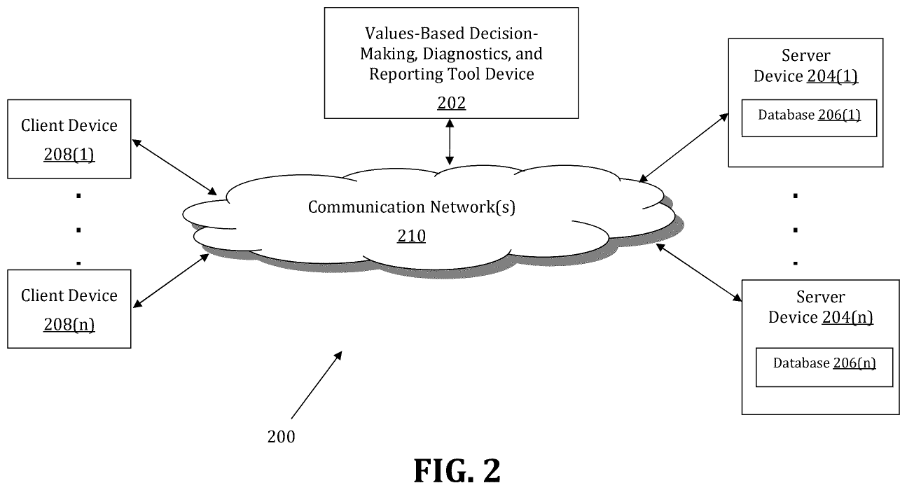

Referring to FIG. 2, a schematic of an exemplary network environment 200 an exemplary network environment that implements a Values-based Decision-making, Diagnostics, and Reporting Tool, is illustrated. In an exemplary embodiment, the Values-based Decision-making, Diagnostics, and Reporting Tool may be implemented on any networked computer platform, such as, for example, a personal computer (PC).

A method for implementing technology for values-based decision-making, diagnostics, and reporting may be implemented by an Values-based Decision-making, Diagnostics, and Reporting Tool (VDDRT) device 202. The VDDRT device 202 may be the same or similar to the computer system 102 as described with respect to FIG. 1. The VDDRT device 202 may be a rack-mounted server in a datacenter, an embedded microcontroller (MCU) in an electronic device, or another type of headless system, which is a computer system or device that is configured to operate without a monitor, keyboard and mouse. The VDDRT device 202 may store one or more applications that can include executable instructions that, when executed by the VDDRT device 202, cause the VDDRT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the VDDRT device 202 itself, may be located in virtual server(s) running in a cloud-based computing environment rather than being tied to one or more specific physical network computing devices. Also, the application(s) may be running in one or more virtual machines (VMs) executing on the VDDRT device 202. Additionally, in one or more embodiments of this technology, virtual machine(s) running on the VDDRT device 202 may be managed or supervised by a hypervisor.

In the network environment 200 of FIG. 2, the VDDRT device 202 is coupled to a plurality of server devices 204(1)-204(n) that hosts a plurality of databases 206(1)-206(n), and also to a plurality of client devices 208(1)-208(n) via communication network(s) 210. A communication interface of the VDDRT device 202, such as the network interface 114 of the computer system 102 of FIG. 1, operatively couples and communicates between the VDDRT device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the VDDRT device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, computer readable media, and VDDRT devices that efficiently implement a method for a Values-based Decision-making, Diagnostics, and Reporting Tool that improves the overall speed, ease, and user experience of cyber defense capability assessment tasks.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The VDDRT device 202 may be a standalone device or integrated with one or more other devices or apparatuses, such as one or more of the server devices 204(1)-204(n), for example. In one particular example, the VDDRT device 202 may include or be hosted by one of the server devices 204(1)-204(n), and other arrangements are also possible. As another example, the VDDRT device 202 may be integrated with one or more other devices or apparatuses, such as one or more of the client devices 208(1)-208(n). Moreover, one or more of the devices of the VDDRT device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the VDDRT device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to a variety of databases.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the VDDRT device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the VDDRT device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the VDDRT device 202, the server devices 204(1)-204(n), the databases 206(1)-206(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the VDDRT device 202, the server devices 204(1)-204(n), the databases 206(1)-206(n), or the client devices 208(1)-208(n), for example, may be configured to operate as virtual instances on the same physical machine. In other words, one or more of the VDDRT device 202, the server devices 204(1)-204(n), the databases 206(1)-206(n), or the client devices 208(1)-208(n) may operate on the same physical device rather than as separate devices communicating through communication network(s) 210. Additionally, there may be more or fewer VDDRT devices 202, server devices 204(1)-204(n), databases 206(1)-206(n), or client devices 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

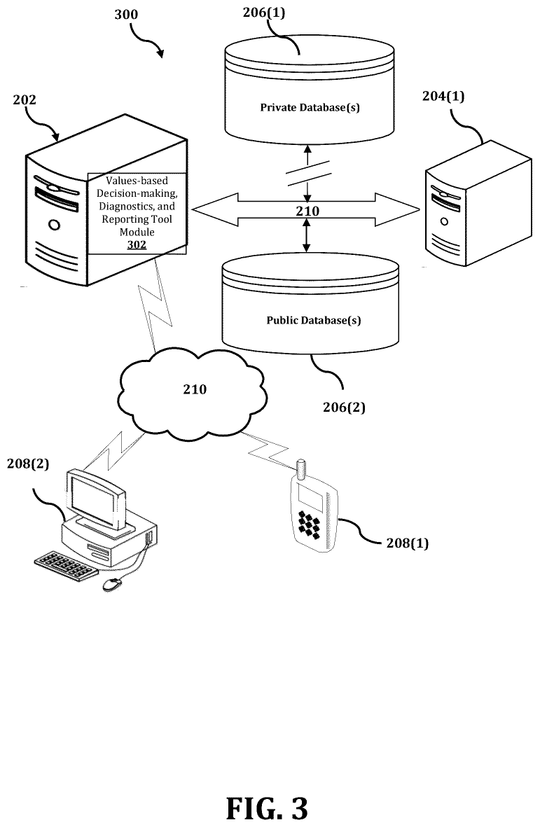

The VDDRT device 202 is described and illustrated in FIG. 3 as including Values-based Decision-making, Diagnostics, and Reporting Tool module 302, although it may include other rules, policies, modules, databases, or applications, for example. As will be described below, Values-based Decision-making, Diagnostics, and Reporting Tool module 302 is configured to evaluate how a client's values align with values-based information pertaining to one or more businesses. Values-based Decision-making, Diagnostics, and Reporting Tool module 302 may include software that is based on a microservices architecture.

Values-based Decision-making, Diagnostics, and Reporting Tool module 302 may be integrated with one or more devices or apparatuses, such as client devices 208(1)-208(n), where Values-based Decision-making, Diagnostics, and Reporting Tool module 302 may be implemented as an application or as an addon or plugin to another application of the one or more devices or apparatuses, and where Values-based Decision-making, Diagnostics, and Reporting Tool module 302 may execute in the background.

An exemplary process 300 for application of a Values-based Decision-making, Diagnostics, and Reporting Tool to an aspect of the network environment of FIG. 2 is illustrated as being executed in FIG. 3. Specifically, a first client device 208(1) and a second client device 208(2) are illustrated as being in communication with VDDRT device 202. In this regard, the first client device 208(1) and the second client device 208(2) may be “clients” of the VDDRT device 202 and are described herein as such. Nevertheless, it is to be known and understood that the first client device 208(1) and/or the second client device 208(2) need not necessarily be “clients” of the VDDRT device 202, or any entity described in association therewith herein. Any additional or alternative relationship may exist between either or both of first client device 208(1), second client device 208(2) and VDDRT device 202, or no relationship may exist.

Further, VDDRT device 202 is illustrated as being able to access private database(s) 206(1), and public database(s) 206(2). VDDRT device 202 may comprise a Values-based Decision-making, Diagnostics, and Reporting Tool that communicates with public database(s) 206(1). In addition, the Values-based Decision-making, Diagnostics, and Reporting Tool of VDDRT device 202 may also communicate with public database(s) 206(2). The Values-based Decision-making, Diagnostics, and Reporting Tool module 302 may be configured to access these databases in order to evaluate how a client's values align with values-based information pertaining to one or more businesses.

Moreover, VDDRT device 202 may receive and transmit data via communication network(s) 210. VDDRT device 202 may receive and transmit data such as code that is written in one or more of the following dialects: transaction control language (TCL), data manipulation language (DML), data control language (DCL) and data definition language (DFL). Additionally, via communication network(s) 210, VDDRT device 202 may respectively receive and transmit data from and to one or more of the following devices: server device 204(1), private database(s) 206(1), public database(s) 206(2), first client device 208(1), the second client device 208(2), and communication network(s) 210, for example.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The client devices 208(1)-208(n) may represent, for example, computer systems of an organization or database network. The first client device 208(1) represent, for example, one or more computer systems of a department or cluster within the organization or database network. Of course, the first client device 208(1) may include one or more of any of the devices described herein. The second client device 208(2) may be, for example, one or more computer systems of another department or cluster within the organization or database network. Of course, the second client device 208(2) may include one or more of any of the devices described herein.

The process may be executed via the communication network(s) 210, which may comprise plural networks as described above. For example, in an exemplary embodiment, either or both of the first client device 208(1) and the second client device 208(2) may communicate with the VDDRT device 202 via broadband or cellular communication. Of course, these embodiments are merely exemplary and are not limiting or exhaustive.

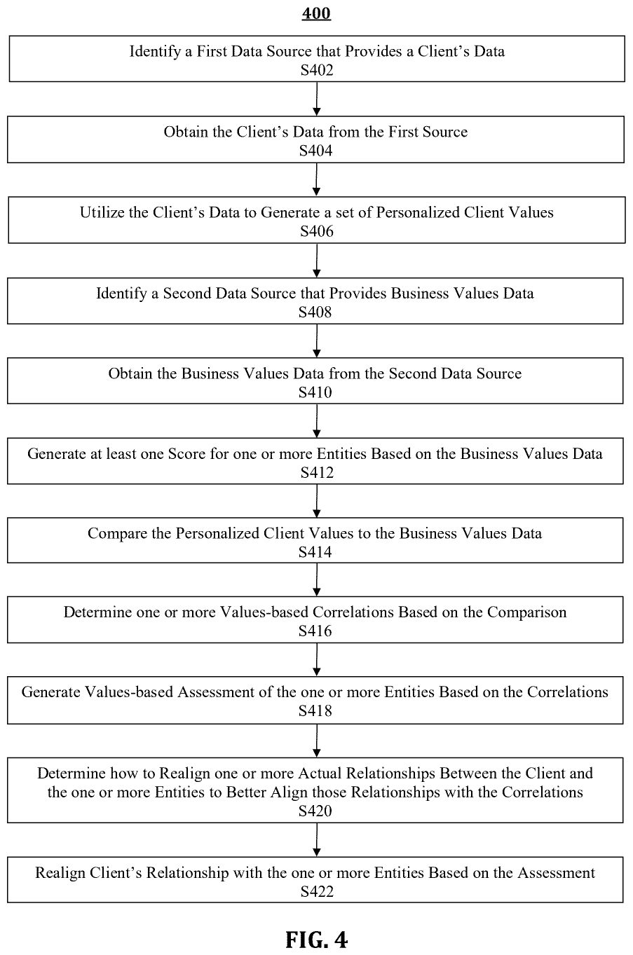

Values-based Decision-making, Diagnostics, and Reporting Tool module 302 may execute a process for implementing a Values-based Decision-making, Diagnostics, and Reporting Tool that evaluates how a client's values align with values-based information pertaining to one or more businesses. An exemplary process for implementing a Values-based Decision-making, Diagnostics, and Reporting Tool is generally indicated at flowchart 400 in FIG. 4.

In process 400 of FIG. 4, at step S402, Values-based Decision-making, Diagnostics, and Reporting Tool module 302 identifies one or more first data sources. The one or more first data sources store, and are capable of providing, client data such as one or more from among a client preference, a client behavior, and a client profile. The one or more first data sources may be identified by searching a network for any databases that store an identifier of a client, such as the client's legal name, username, alias, identification number, phone number, email address, residential address, business address, etc. The client may represent one or more from among an individual, organization, or other entity, and the client may comprise one of client devices 208(1)-208(n), for example. The one or more first data sources may comprise any data source, such as a datacenter and/or a website, which may each comprise one or more from among private database(s) 206(1) and public database(s) 206(2).

At step S404, Values-based Decision-making, Diagnostics, and Reporting Tool module 302 obtains the client's data from the first data source. The client's data may be obtained from the first data source by performing any of a number of operations, such as downloading, scraping, etc.

At step S406, Values-based Decision-making, Diagnostics, and Reporting Tool module 302 utilizes the client's data to generate a set of personalized client values, which is information regarding one or more values of the client. These one or more values of the client may include one or more values pertaining to one or more businesses (such as one or more from among geographical proximity/location values and/or ESG values, for example). Values-based Decision-making, Diagnostics, and Reporting Tool module 302 may include a decision-making scoring engine that is responsible for this generation of the set of personalized client values. The decision-making scoring engine may comprise one or more from among an algorithm, a software module, artificial intelligence and/or machine learning (AI/ML), etc. The set of personalized client values may be generated, at step S406, by first evaluating the client's data to determine the one or more values of the client, then converting the one or more values of the client into the set of personalized client values that may indicate how strongly the client feels towards each of the one or more values. In an exemplary embodiment, the set of personalized client values may additionally or alternatively be utilized to train an AI/ML model and, then, the trained AI/ML model may interact with business values data.

At step S408, Values-based Decision-making, Diagnostics, and Reporting Tool module 302, identifies one or more second data sources. The one or more second data sources store, and are capable of providing, business values data such as information that indicates, for example, at least one values-based impact of at least one business or entity associated with the at least one business. The one or more second data sources may be identified by searching a network for any databases storing an identifier of any products. The one or more second data sources may comprise any data source, such as a datacenter and/or a website, which may each comprise one or more from among private database(s) 206(1) and public database(s) 206(2).

At step S410, Values-based Decision-making, Diagnostics, and Reporting Tool module 302 obtains business values data from the second data source. The business values data may be obtained from the second data source by performing any of a number of operations, such as downloading, scrapping, etc.

At step S412, Values-based Decision-making, Diagnostics, and Reporting Tool module 302 generates at least one score for at least one values-based attribute of one or more entities based on the business values data that has been obtained from the second data source at step S410. In an embodiment, Values-based Decision-making, Diagnostics, and Reporting Tool module 302 may generate the at least one score by searching the business value data for information pertaining to the at least one values-based attribute, and utilizing such pertinent information to produce a respective scoring scale for each of the at least one values-based attribute.

In the embodiment, Values-based Decision-making, Diagnostics, and Reporting Tool module 302 may produce the respective scoring scale by evaluating each corresponding entity's pertinent business data information to determine a mapping from values of the pertinent business data to scores of business entities. This mapping may be informed, among other things, by: (1) statistical measures relating to the pertinent business data; and (2) a conceptual interpretation of the pertinent business data.

At step S414, Values-based Decision-making, Diagnostics, and Reporting Tool module 302 compares the set of personalized client values to the business values data and/or business values data scores to determine whether the set of personalized client values correlates to any information in the business values data and/or business values data scores. Values-based Decision-making, Diagnostics, and Reporting Tool module 302 may utilize one or more from among an algorithm, a software module, artificial intelligence and/or machine learning (AI/ML), etc., to carry out this comparison.

Based on this comparison, Values-based Decision-making, Diagnostics, and Reporting Tool module 302 determines values-based correlations at step S416. The values-based correlations may comprise one or more relationships between at least one first value of the client and the business values data, and the business values data may comprise at least one first corresponding impact or policy of at least one business or entity associated with the at least one business. Values-based Decision-making, Diagnostics, and Reporting Tool module 302 may utilize one or more from among an algorithm, a software module, artificial intelligence and/or machine learning (AI/ML), etc., to determine these correlations.

These values-based correlations that are determined, at step S416, may indicate that at least one value of the client is aligned with the at least one corresponding impact or policy of the at least one business or associated entity. Additionally, the values-based correlations may indicate that at least one second value of the client conflicts with at least one second corresponding impact or policy of the at least one business or associated entity. The values-based correlations may also indicate at least one first degree to which the at least one first value aligns with the business values data. Similarly, the values-based correlations may also indicate at least one second degree to which the at least one second value conflicts with the business values data.

At step S418, Values-based Decision-making, Diagnostics, and Reporting Tool module 302 generates a values-based assessment of the at least one business or associated entity, based on the values-based correlations. The values-based assessment may include an optimization feature. The optimization feature may comprise one or more from among a suggestion that the client: acquire at least a first product, dissolve a relationship to at least a second product, contribute to at least one entity, dissolve a relationship with the at least one entity; acquire at least a first basket of products; and dissolve a relationship to at least a second basket of products.

The first and second basket of products may each comprise a distinct customized basket of products that has been tailored to one or more of the client's values. Additionally, or alternatively, the first and second basket of products may each also comprise at least one standardized index of products. Additionally, or alternatively, the values-based assessment may include a reporting feature. The reporting feature may comprise a values-based report regarding the client's actual relationship(s) (e.g., investment relationships, spending relationships, donation relationships, voting relationships, etc.) with the at least one business or associated entity. Additionally, or alternatively, the values-based assessment may include an “upcoming elections” feature. The “upcoming elections” feature may comprise a values-based assessment that indicates how client's values align with values of candidates for upcoming elections that pertain to the client. For the purposes of this disclosure, a candidate may refer to, but is not limited to, one or more from among at least one individual and at least one policy.

At step S420, Values-based Decision-making, Diagnostics, and Reporting Tool module 302 evaluates the values-based assessment of the at least one business or associated entity, and determines how to realign the client's relationship with the at least one business or associated entity in a manner that will improve an alignment of one or more actual relationships between the client and the at least one business or associated entity. In an embodiment, the realignment determined at step S420 may be subjected to an approval process before process 400 proceeds to step S422.

In a further embodiment, the determination of step S420 may include a recommendation, for example, which may comprise at least one from among a recommendation to acquire or increase a first ownership interest in at least one first product and a recommendation to discontinue, dissolve, or reduce the magnitude of a relationship with or second ownership interest in at least one second product. In an exemplary embodiment, a product may include a financial instrument, which may comprise one from among an equity instrument and a debt instrument. In an additional or alternative embodiment, a product may include one or more from among a donation, business product and/or service, for example.

Turning to step S422, although optional, at step S422, Values-based Decision-making, Diagnostics, and Reporting Tool module 302 improves an alignment of one or more actual relationships between the client and the at least one business or associated entity. In an embodiment, Values-based Decision-making, Diagnostics, and Reporting Tool module 302 may perform step S422 in response to receiving an approval of an approval process, as input via an interface such as at least one from among a network interface and a user interface, for example.

Similarly, although optional, at step S422, Values-based Decision-making, Diagnostics, and Reporting Tool module 302 may improve the alignment of the client's actual relationships to the at least one business or associated entity to better align with the values-based correlations that were determined at step S414. After step S422, process 400 may end. However, after step S422, Values-based Decision-making, Diagnostics, and Reporting Tool module 302 may also repeat process 400 for a second client, then may repeat process 400 yet again for a third client, and so on, and so forth.

One or more from among steps S402-S416 may be performed using any of a number of means, such as natural language processing, for example.

In an exemplary embodiment, the client's actual relationship to the at least one business or associated entity may be improved by at least one from among acquiring a first ownership interest in at least one first business and dissolving a second ownership interest in at least one second business. In the exemplary embodiment, where a product may comprise one from among an equity instrument and a debt instrument. Additionally, or alternatively, a product may include one or more from among a donation, business product and/or service.

For the purposes of this disclosure, the herein-disclosed AI/ML may utilize, but is not limited to utilizing, one or more deep learning technologies such as large language models (LLM) to serve as a proxy for one or more of the previously mentioned functions of the AI/ML disclosed herein. In addition, the AI/ML may also utilize LLM to serve as a proxy for responding to one or more user inquiries, which may originate from one or more devices such as client devices 208. For example, a user may pose a question to an AI/ML model and the AI/ML model may utilize one or more deep learning technologies, such as LLM, to generate a response to the user's question.

Additionally, for the purposes of this disclosure, the phrase “values-based” may describe one or more from among location values, geographical proximity values, moral values and principles (such as environmental, social, and/or governance (ESG) values and/or principles, or other values), and the herein-disclosed values-based information may refer to and/or include, but is not limited to, a customized decision-making strategy that may be tailored to one or more from among a location-based decision-making strategy and a religious-based decision-making strategy. For the purposes of this disclosure, a location-based decision-making strategy may include a decision-making strategy that is based on one or more proximities to one or more geographical locations. Similarly, a religious-based decision-making strategy may include a decision-making strategy that is based at least one from among a religious value and a spiritual value.

Moreover, for the purposes for this disclosure, the herein-disclosed portfolio may pertain to a particular client and may refer to at least one client-held product. However, the herein-disclosed portfolio is not limited to client-held products, and the herein-disclosed portfolio may additionally or alternatively refer to one or more from among at least one of the particular client's acquisitions, at least one of the particular client's gifts to another entity, and at least one of the client's gifts from another entity.

Furthermore, for the purposes of this disclosure, the herein-disclosed product may refer to, but is not limited to, at least one from among at least one financial instrument and at least one non-financial instrument. In addition, the herein-disclosed financial instrument may refer to, but is not limited to, one or more from among at least one debt, at least one equity, and at least one financial instrument that is neither a debt nor an equity. Moreover, the herein-disclosed businesses may refer to, but is not limited to, one or more from among at least one for-profit organization and at least one non-profit organization although a non-profit organization may colloquially be referred to as a non-business entity.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded Is illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for implementing a values-based decision-making, diagnostics, and reporting tool, the method comprising:
identifying at least one first source that provides client data that indicates at least one from among a client preference, a client behavior, and a client profile;
obtaining the client data from the at least one first source;
utilizing the client data to generate a set of personalized client values that indicates a set of values of a client; and
utilizing the set of personalized client values to generate a values-based assessment for the client.

2. The method of claim 1, wherein the values-based assessment comprises: at least one nonprofit organization that is associated with values-based information that aligns with the set of personalized client values of the client.

3. The method of claim 1, wherein generating the values-based assessment comprises:
identifying at least one second source that provides business values data that comprises values-based information that is associated with an entity that is associated with a business, wherein the values-based information comprises information that indicates at least one values-based value of the entity that is associated with the business;
obtaining the business values data from the at least one second source;
determining at least one values-based correlation by comparing the set of personalized client values to the business values data; and
utilizing the at least one values-based correlation to generate the values-based assessment, wherein the values-based assessment comprises an indication of the at least one values-based correlation.

4. The method of claim 3, further comprising:
utilizing natural language processing (NLP) to search a data network for at least one from among the client data and the business values data;
identifying a source of the at least one from among the client data and the business values data; and
determining that at least one from among the first source and the second source corresponds to the source of the at least one from among the client data and the business values data comprises, respectively.

5. The method of claim 3, wherein the values-based assessment further comprises a customized basket of a plurality of specified products that are associated with one or more entities that are each associated with conforming values-based information that aligns with the set of personalized client values of the client.

6. The method of claim 3, wherein the generating the values-based assessment further comprises:
utilizing the business values data to identify, from a portfolio of the client, at least one client-held product that is associated with at least one entity that is associated with nonconforming values-based information that conflicts with the set of personalized client values of the client; and
generating a notification that indicates that the at least one client-held product is associated with the at least one entity that is associated with the nonconforming values-based information that conflicts with the set of personalized client values of the client.

7. The method of claim 6, further comprising:
generating a report that indicates how the at least one value of the client relates to each entity that is associated with one or more products from the portfolio of the client,
wherein the report comprises one or more impact metrics that indicate how the portfolio impacts one or more corresponding values of the client.

8. The method of claim 7, wherein the product includes a financial instrument that comprises one from among an equity instrument and a debt instrument.

9. The method of claim 7, wherein the one or more impact metrics utilize a standardized index as a baseline for indicating how the portfolio impacts the one or more corresponding values.

10. A system for implementing a values-based decision-making, diagnostics, and reporting tool, the system comprising:
a processor; and
memory storing executable instructions that, when executed by the processor, cause the processor to:
identify at least one first source that provides client data that indicates at least one from among a client preference, a client behavior, and a client profile;
obtain the client data from the at least one first source;
utilize the client data to generate a set of personalized client values that indicates a set of values of a client; and
utilize the set of personalized client values to generate an values-based assessment for the client.

11. The system of claim 10, wherein the values-based assessment comprises: at least one nonprofit organization that is associated with values-based information that aligns with the set of personalized client values of the client.

12. The system of claim 10, wherein when executed by the processor, the instructions further cause the processor to generate the values-based assessment by:
identifying at least one second source that provides business values data that comprises values-based information that is associated with an entity that is associated with a business, wherein the values-based information comprises information that indicates at least one value of the entity that is associated with the business;
obtaining the business values data from the at least one second source;
determining at least one values-based correlation by comparing the set of personalized client values to the business values data; and
utilizing the at least one values-based correlation to generate the values-based assessment, wherein the values-based assessment comprises an indication of the at least one values-based correlation.

13. The system of claim 12, wherein when executed by the processor, the instructions further cause the processor to:
utilize natural language processing (NLP) to search a data network for at least one from among the client data and the business values data;
identifying a source of the at least one from among the client data and the business values data; and
determining that at least one from among the first source and the second source corresponds to the source of the at least one from among the client data and the business values data, respectively.

14. The system of claim 12, wherein the values-based assessment further comprises a customized basket of a plurality of specified products that are associated with one or more entities that are each associated with conforming values-based information that aligns with the set of personalized client values of the client.

15. The system of claim 12, wherein when executed by the processor, the instructions further cause the processor to perform the generating the values-based assessment by:
utilizing the business values data to identify, from a portfolio of the client, at least one client-held product that is associated with at least one entity that is associated with nonconforming values-based information that conflicts with the set of personalized client values of the client; and
generating a notification that indicates that the at least one client-held product is associated with the at least one entity that is associated with the nonconforming values-based information that conflicts with the set of personalized client values of the client.

16. The system of claim 15, wherein when executed by the processor, the instructions further cause the processor to:
generate a report that indicates how the at least one value of the client relates to each entity that is associated with one or more products from the portfolio of the client,
wherein the report comprises one or more impact metrics that indicate how the portfolio impacts one or more corresponding values of the client.

17. The system of claim 16, wherein the product includes a financial instrument that comprises one from among an equity instrument and a debt instrument.

18. The system of claim 16, wherein the one or more impact metrics utilize a standardized index as a baseline for indicating how the portfolio impacts the one or more corresponding values.

19. A non-transitory computer-readable medium for implementing a values-based decision-making, diagnostics, and reporting tool, the non-transitory computer-readable medium storing instructions that, when executed by a processor, cause a processor to:
identify at least one first source that provides client data that indicates at least one from among a client preference, a client behavior, and a client profile;
obtain the client data from the at least one first source;
utilize the client data to generate a set of personalized client values that indicates a set of values of a client; and
utilize the set of personalized client values to generate an values-based assessment for the client.

20. The non-transitory computer-readable medium of claim 19, wherein when executed by the processor, the instructions further cause the processor to generate the values-based assessment by:
identifying at least one second source that provides business values data that comprises values-based information that is associated with an entity that is associated with a business, wherein the values-based information comprises information that indicates at least one value of the entity that is associated with the business;
obtaining the business values data from the at least one second source;
determining at least one values-based correlation by comparing the set of personalized client values to the business values data; and
utilizing the at least one values-based correlation to generate the values-based assessment, wherein the values-based assessment comprises an indication of the at least one values-based correlation.
